(19) United States
(12) Patent Application Publication
(10) Pub. No.: US 2026/0153137 A1
(43) Pub. Date: Jun. 4, 2026

(54) AIR COMPRESSOR FOR TIRE FILLING SYSTEM

(71) Applicant: Deere & Company, Moline, IL (US)

(72) Inventor: FRANK BUHRKE, Mannheim (DE)

(21) Appl. No.: 19/344,750

(22) Filed: Sep. 30, 2025

(30) Foreign Application Priority Data
Oct. 18, 2024 (EP) 24207477.1

(51) Int. Cl. F16H 3/48

(52) U.S. Cl. CPC F16H 3/48; F16H 2200/0034; F16H 2200/2007; F16H 2200/2035

(57) ABSTRACT

An air compressor for a tire filling system comprises a compressor unit and a gear unit. The compressor unit generates compressed air and has a drive shaft. The gear unit, which can be switched between a first and a second transmission ratio, has an input shaft for connection to a driving device and an output shaft connected to the drive shaft of the compressor unit.

### CROSS-REFERENCE TO RELATED APPLICATIONS

This application claims priority to European Patent Application No. 24207477.1, filed Oct. 18, 2024, which is hereby incorporated by reference.

### TECHNICAL FIELD

The present disclosure relates generally to an air compressor for a tire filling system.

### BACKGROUND

In the agricultural machine sector, there is increasing use of tire filling systems which allow adaptation of the tire filling pressure and thus of the tire contact area to different ground conditions with the aim of avoiding unwanted ground compaction effects. To fill the tires, use is made of an air compressor with a compressor unit that generates compressed air, which is typically driven via a belt or gear drive of an internal combustion engine. The transmission ratio of the belt or gear drive is chosen so that even high engine speeds cannot lead to mechanical overloading of the compressor unit. Conversely, however, this means that there may be an undersupply of compressed air and associated excessive tire filling times at relatively low engine speeds.

### SUMMARY

It is the object of the present disclosure to specify an air compressor of the type stated at the outset which is improved in respect of the constancy of compressed air generation.

This object is achieved by an air compressor for a tire filling system having the features of one or more embodiments disclosed herein.

The air compressor according to the disclosure for a tire filling system comprises a compressor unit, which generates compressed air and has a drive shaft, and a gear unit, which can be switched between a first and a second transmission ratio and has an input shaft for connection to a driving device and an output shaft connected to the drive shaft of the compressor unit. By appropriate choice of the transmission ratios, it is possible to achieve compressed air generation that is improved in respect of its constancy over the entire speed range of the driving device, and this applies particularly when the driving device is an internal combustion engine with a belt or gear drive, by which the input shaft of the gear unit can be set in rotation.

Advantageous developments of the air compressor according to the disclosure for a tire filling system can be found in one or more embodiments disclosed herein.

The gear unit may comprise a first planetary gear with a first sun wheel, which is rotationally connected to the input shaft, and a second planetary gear with a second sun wheel, which is rotationally connected to the output shaft, wherein, on a common planet carrier, a first planet wheel set is in mesh with the first sun wheel via first planet wheels, and a second planet wheel set is in mesh with the second sun wheel via second planet wheels, wherein the first and second planet wheels each form rotatably interconnected planet wheel pairs, wherein, to switch between the two transmission ratios, it is possible selectively,
(i) in a first operating mode, to block rotation of the planet carrier by a brake fixed to the housing (with the effect that each of the planet wheel pairs forms a countershaft rotationally connecting the two sun wheels),
(ii) in a second operating mode, a direct rotational connection between the input shaft and the output shaft is established by a clutch, bypassing the two planetary gears.

In the case of the direct connection, the first transmission ratio is one, i.e. the speed of the output shaft is identical with that of the input shaft of the gear unit. In contrast, the second transmission ratio is freely selectable and is obtained from the ratios of the numbers of teeth on the sun wheels and planet wheels. Here, the use of series-connected planetary gears with a common planet carrier leads to a compact design of the gear unit.

This characteristic comes into play if, at the same time, the two planetary gears are arranged coaxially with one another in relation to the drive shaft of the compressor unit.

The first transmission ratio is assigned to a first speed range, whereas the second transmission ratio is assigned to a second, higher speed range of the driving device. Thus, in the first operating mode, there is a speed increase between the input and output shafts of the gear unit. In such a case, the numbers of teeth of the sun wheels and planet wheels bear the following relationship to one another:

S1>P1 and P2>S2,

where S1 and S2 denote the number of teeth on the first and second sun wheel, respectively, and P1 and P2 denote the number of teeth on the first and second planet wheel, respectively.

Here, switching between the two transmission ratios can take place according to a speed at the input shaft on initiation by a control unit, switching being accomplished by pneumatic or else hydraulic actuation of respective actuators assigned to the brake and the clutch. In the case of pneumatic actuation, the required air pressure is generated or provided by the air compressor itself and is temporarily stored in a buffer accumulator. The clutch is closed under spring loading during the starting phase of the driving device and can be opened only when a minimum air pressure sufficient for actuation, of the order of 6 to 7 bar, has been achieved.

By simultaneous opening of the brake and the clutch, it is also possible to completely divide the drive connection to the compressor unit. This makes it possible to save driving energy in operating phases in which generation of compressed air is not currently required.

Other features and aspects will become apparent by consideration of the detailed description, claims, and accompanying drawings.

### BRIEF DESCRIPTION OF THE DRAWINGS

The air compressor according to the disclosure for a tire filling system is explained in more detail below using the attached drawings. Corresponding components or those with comparable function are identified by the same reference signs.

FIG. 1 shows a perspective sectioned view of one exemplary embodiment of the air compressor according to the disclosure for a tire filling system.

FIG. 2 shows a schematic partial view of the air compressor according to the disclosure depicted in FIG. 1, with a gear unit in a first operating mode.

FIG. 3 shows a schematic partial view of the air compressor according to the disclosure depicted in FIG. 1, with the gear unit in a second operating mode.

Like reference numerals are used to indicate like elements throughout the several figures.

### DETAILED DESCRIPTION

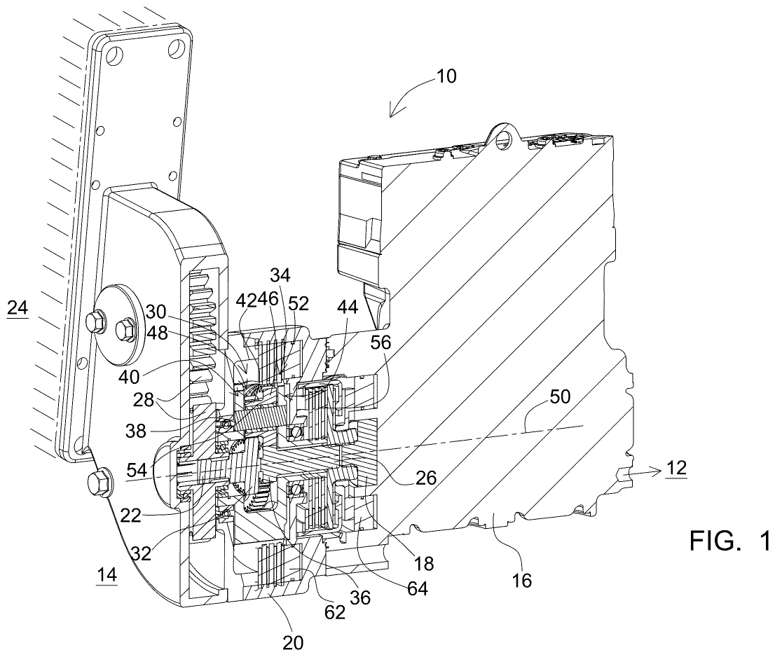

FIG. 1 shows a perspective sectioned view of one exemplary embodiment of the air compressor according to the disclosure for a tire filling system.

The air compressor 10, which is designed as an integrated assembly, is a component part of a tire filling system 12 (not shown in FIG. 1), which is located in an agricultural machine designed as an agricultural tractor 14. The basic construction of a tire filling system 12 of this kind is sufficiently well known, and the following description is therefore restricted to the air compressor 10, which is provided for generating compressed air and is ultimately used to fill associated tires of the agricultural tractor 14.

As can be seen in FIG. 1, the air compressor 10 comprises a compressor unit 16, which generates compressed air and has a drive shaft 18, and a gear unit 20, which can be switched between a first and a second transmission ratio and has an input shaft 22 for connection to a driving device 24 and an output shaft 26 connected to the drive shaft 18 of the compressor unit 16.

In the present case, the driving device 24 is a diesel internal combustion engine (not shown), wherein the input shaft 22 of the gear unit 20 is in constant mesh with a gear drive of the internal combustion engine via an input gearwheel pair 28 and in this way is set in rotation.

More specifically, the gear unit 20 comprises a first planetary gear 30 with a first sun wheel 32 rotationally connected to the input shaft 22, and a second planetary gear 34 with a second sun wheel 36 rotationally connected to the output shaft 26. On a common planet carrier 38, a first planet wheel set 40 is in mesh with the first sun wheel 32 via first planet wheels 42, and a second planet wheel set 44 is in mesh with the second sun wheel 36 via second planet wheels 46. First and second planet wheels 42, 46 each form rotatably interconnected planet wheel pairs 48. Each of the planet wheel pairs 48 can be a forging, on which a respective first and second planet wheel 42, 46 is integrally formed. In this case, the planet wheel pairs 48 are attached in a uniformly distributed manner along the circumference of the common planet carrier 38.

For the sake of space-saving construction, the two planetary gears 30, 34 are arranged coaxially with one another in relation to the drive shaft 18 of the compressor unit 16. Thus, the input, output and drive shafts 22, 26, 18 extend along a common axis of rotation 50.

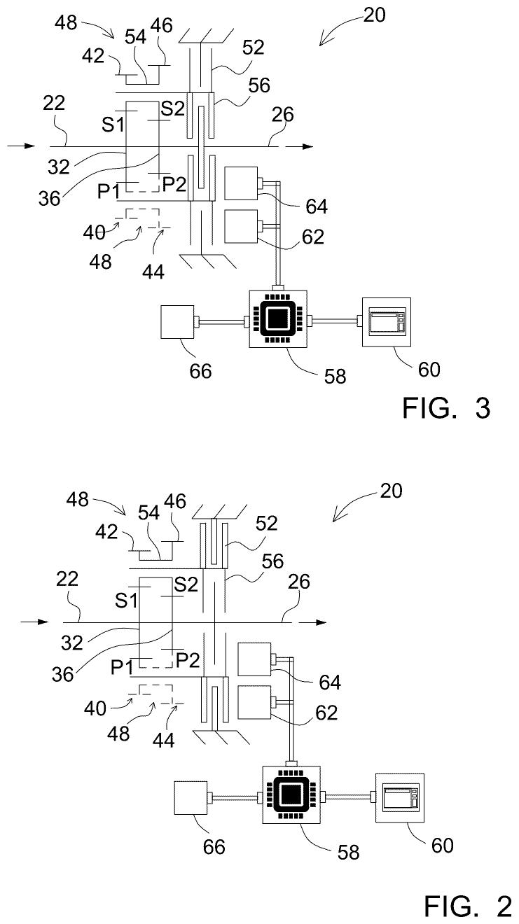

To switch between the two transmission ratios, it is possible selectively,
(i) in a first operating mode shown in FIG. 2, to block rotation of the planet carrier 38 by means of a brake 52 fixed to the housing, with the effect that each of the planet wheel pairs 48 forms a countershaft 54 rotationally connecting the two sun wheels 32, 36,
(ii) in a second operating mode shown in FIG. 3, to establish a direct rotational connection between the input shaft 22 and the output shaft 26 by means of a clutch 56, bypassing the two planetary gears 30, 34.

In the case of the direct connection, the first transmission ratio is one, i.e. the speed of the output shaft 26 is identical with that of the input shaft 22 of the gear unit 20. In contrast, the second transmission ratio is freely selectable and is obtained from the ratios of the numbers of teeth on the sun wheels 32, 36 and planet wheels 42, 46.

The first transmission ratio is assigned to a first speed range, whereas the second transmission ratio is assigned to a second, higher speed range of the internal combustion engine. Thus, in the first operating mode, there is a speed increase between the input and output shafts 22, 26 of the gear unit 20. In such a case, the numbers of teeth of the sun wheels 32, 36 and planet wheels 42, 46 bear the following relationship to one another:

$$S 1 > P 1 and P 2 > S 2 ,$$

where S1 and S2 denote the number of teeth on the first and second sun wheel 32, 36, respectively, and P1 and P2 denote the number of teeth on the first and second planet wheel 42, 46, respectively.

Here, switching between the two transmission ratios takes place according to a speed at the input shaft 22 of the gear unit 20 on initiation by a control unit 58, which is a component part of the tire filling system 12 of the agricultural tractor 14, which system can be operated via a user interface 60, switching being accomplished by pneumatic actuation of respective actuators 62, 64 assigned to the brake 52 and the clutch 56. The latter speed is detected by means of a speed sensor 66 assigned to the input shaft 22. According to the example, the brake 52 and the clutch 56 are designed as a disk brake or multiplate clutch, respectively.

The air pressure required for pneumatic actuation of the brake 52 and clutch 56 is generated or provided by the air compressor 10 itself and is temporarily stored in a buffer accumulator (not shown). The clutch 56 is closed under spring loading during the starting phase of the internal combustion engine and can be opened only when a minimum air pressure sufficient for actuation, of the order of 6 to 7 bar, has been achieved.

By simultaneous opening of the brake 52 and the clutch 56, it is also possible to completely divide the drive connection to the compressor unit 16. This makes it possible to save driving energy in operating phases in which generation of compressed air is not currently required.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An air compressor for a tire filling system, comprising:
a compressor unit configured to generate compressed air and having a drive shaft, and
a gear unit, which can be switched between a first and a second transmission ratio, having an input shaft for connection to a driving device and an output shaft connected to the drive shaft of the compressor unit.

2. The air compressor of claim 1, wherein the gear unit comprises a first planetary gear with a first sun wheel, which is rotationally connected to the input shaft, and a second planetary gear with a second sun wheel, which is rotationally connected to the output shaft, and
wherein, on a common planet carrier, a first planet wheel set is in mesh with the first sun wheel via first planet wheels, and a second planet wheel set is in mesh with the second sun wheel via second planet wheels, wherein the first and second planet wheels each form rotatably interconnected planet wheel pairs, wherein, to switch between the first and the second transmission ratios selectively in a first operating mode and a second operating mode, a brake, fixed to the housing, blocks rotation of the planet carrier in the first operating mode, and in the second operating mode, a clutch establishes a direct rotational connection between the input shaft and the output shaft to bypass the first and second planetary gears.

3. The air compressor of claim 1, wherein the first and the second planetary gears are arranged coaxially with one another in relation to the drive shaft of the compressor unit.

4. The air compressor of claim 1, wherein, in the first operating mode, there is a speed increase between the input and output shafts of the gear unit.

5. The air compressor of claim 2, wherein the first and second planetary gears are arranged coaxially with one another in relation to the drive shaft of the compressor unit.

6. The air compressor of claim 2, wherein, in the first operating mode, there is a speed increase between the input and output shafts of the gear unit.
